(19) United States
(12) Patent Application Publication
(10) Pub. No.: US 2015/0235000 A1
(43) Pub. Date: Aug. 20, 2015

(54) DEVELOPING HEALTH INFORMATION FEATURE ABSTRACTIONS FROM INTRA-INDIVIDUAL TEMPORAL VARIANCE HETEROSKEDASTICITY

(71) Applicant: INTERNATIONAL BUSINESS MACHINES CORPORATION, ARMONK, NY (US)

(72) Inventors: MARYNA AKUSHEVICH, STAMFORD, CT (US); PEI-YUN HSUEH, NEW YORK, NY (US); PETER MOOIWEER, CARLISLE, MA (US); SREERAM RAMAKRISHNAN, YORKTOWN HEIGHTS, NY (US); SHWETA SHARMA, AVENEL, NJ (US); KE YU, BOSTON, MA (US)

(73) Assignee: INTERNATIONAL BUSINESS MACHINES CORPORATION, ARMONK, NY (US)

(21) Appl. No.: 14/184,129

(22) Filed: Feb. 19, 2014

(51) Int. Cl. G06F 19/00

(52) U.S. Cl. CPC G06F 19/3431

(57) ABSTRACT

A method, system, and/or computer program product automatically abstracts and selects an optimal set of variance-related features that are indicative of an individual outcome and personalized plan selection in health care. An abstracted set of candidate variance-related patient features, which comprise temporally heteroskedastic features, is generated. Each patient feature from the abstracted set of candidate variance-related patient features is optimized by identifying a time period in which variances and heteroskedasticity of each patient feature are maximized, where the optimizing creates an optimal abstracted set of variance-related patient features from the time period in which the variances and heteroskedasticity of each patient feature are maximized. The optimal abstracted set of variance-related patient features is then used for a current patient to predict a particular outcome and/or to create a personalized health care treatment plan.

### BACKGROUND

The present disclosure relates to the field of computers, and specifically to the use of computers in analyzing data. Still more particularly, the present disclosure relates to abstracting and selecting optimal sets of variance-related features related to health care patients.

Disease self-management programs and intervention/care plan monitoring programs are limited by their inability to systematically leverage patient-generated information, especially those that require artful interpretation of the temporal context of the measurement (examples including and not limited to a patient's weight over time, cholesterol levels, blood glucose levels, etc.). While existing techniques (several mobile apps and web-based portals) help in capturing and storing the relevant data, their ability to determine appropriate metrics most sensitive to that individual is limited or non-existent. This is because the techniques do not account for the specific circumstances of the individual in terms of disease progression, medication profiles, and other aspects of care that will have an impact on clinical Key Performance Indicators (KPIs).

### SUMMARY

A method, system, and/or computer program product automatically abstract and select an optimal set of variance-related features that are indicative of an individual outcome and personalized plan selection in health care. An abstracted set of candidate variance-related patient features, which comprise temporally heteroskedastic features, is generated. Each patient feature from the abstracted set of candidate variance-related patient features is optimized by identifying a time period in which variances and heteroskedasticity of each patient feature are maximized, wherein said optimizing creates an optimal abstracted set of variance-related patient features from the time period in which the variances and heteroskedasticity of each patient feature are maximized. The optimal abstracted set of variance-related patient features is compared to a historical set of data for a population of patients to create a predictive set of variance-related patient features, wherein the predictive set of variance-related patient features predict a target health-related outcome of the population of patients. A current patient optimal set of variance-related patient features is generated for a current patient. The optimal set of variance-related patient features for the population of patients is compared to the current patient optimal set of variance-related patient features for the current patient. In response to the optimal set of variance-related patient features for the population of patients matching the current patient optimal set of variance-related patient features for the current patient within a predefined limit, a determination is made as to whether the target health-related outcome matches a predefined health-related outcome for the current patient. In response to the target health-related outcome matching the predefined health-related outcome for the current patient, an alert is issued related to the predefined health-related outcome for the current patient.

### BRIEF DESCRIPTION OF THE SEVERAL VIEWS OF THE DRAWINGS

FIG. 1 depicts an exemplary system and network in which the present disclosure may be implemented;

FIG. 2 illustrates an exemplary architecture and process for developing health information features abstractions;

FIG. 3 depicts a simulated sequence of patient health measurements;

FIG. 4 illustrates an estimated trend variance for the patient health measurements shown in FIG. 3;

FIG. 5 depicts another simulated sequence of patient health measurements;

FIG. 6 depicts a VARiance trend Over Time (VAROT) of patient health measurements depicted in FIG. 5;

FIG. 7 is a table of VAROT measurements according to permutations of various incremental periods of different observation windows used in the measurements shown in FIG. 5; and

FIG. 8 is a high level flow-chart of one or more operations performed by one or more processors to abstract and select an optimal set of variance-related features that are indicative of an individual outcome and personalized plan selection in health care.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

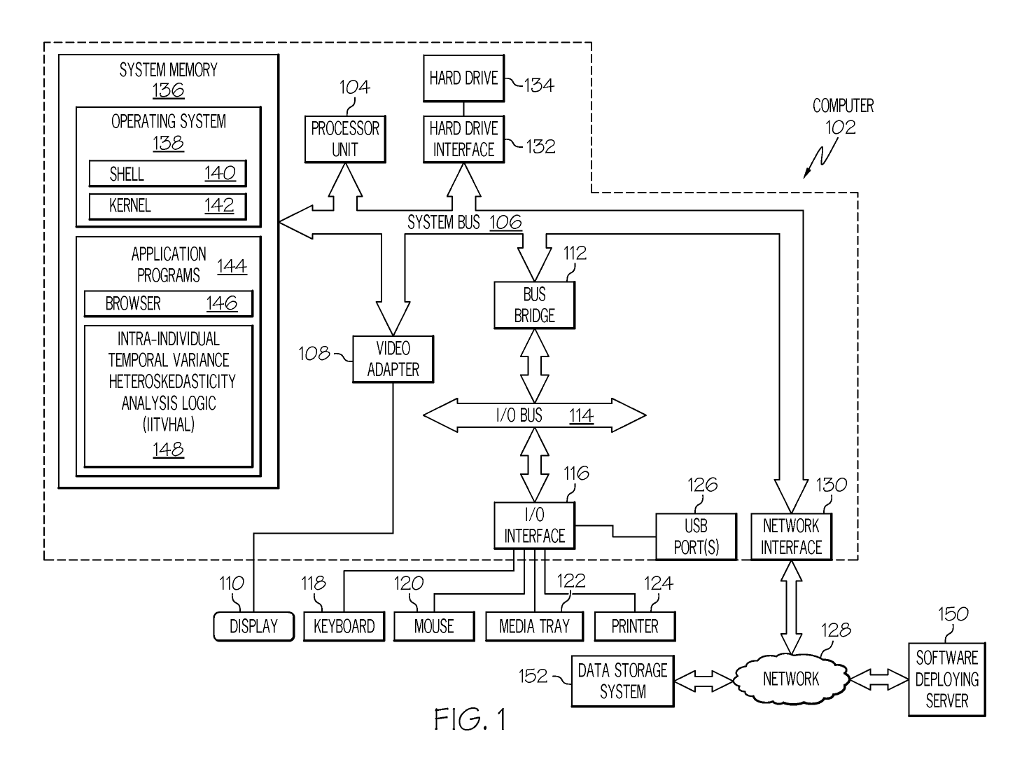

With reference now to the figures, and in particular to FIG. 1, there is depicted a block diagram of an exemplary system and network that may be utilized by and/or in the implementation of the present invention. Note that some or all of the exemplary architecture, including both depicted hardware and software, shown for and within computer 102 may be utilized by software deploying server 150 and/or data storage system 152.

Exemplary computer 102 includes a processor 104 that is coupled to a system bus 106. Processor 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150, using a network interface 130. Network interface 130 is a hardware network interface, such as a network interface card (NIC), etc. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other computer systems.

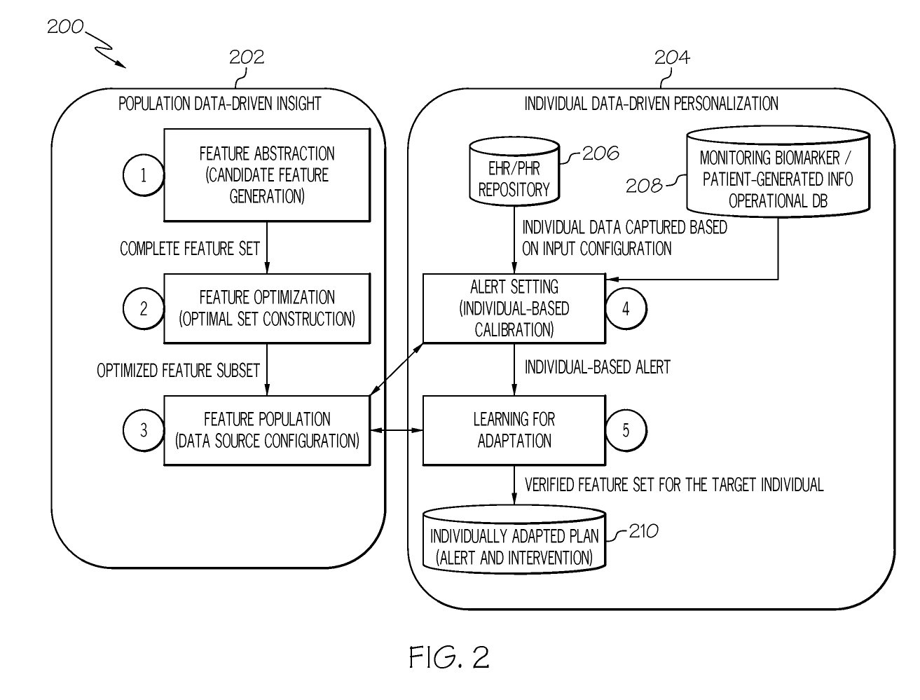

Application programs 144 in computer 102's system memory (as well as software deploying server 150's system memory) also include an Intra-Individual Temporal Variance Heteroskedasticity Analysis Logic (IITVHAL) 148. IITVHAL 148 includes code for implementing the processes described below, including those described in FIGS. 2-8. In one embodiment, computer 102 is able to download IITVHAL 148 from software deploying server 150, including in an on-demand basis, wherein the code in IITVHAL 148 is not downloaded until needed for execution. Note further that, in one embodiment of the present invention, software deploying server 150 performs all of the functions associated with the present invention (including execution of IITVHAL 148), thus freeing computer 102 from having to use its own internal computing resources to execute IITVHAL 148.

Note that the hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

With reference now to FIG. 2, an exemplary architecture and process for developing health information features abstractions is presented. System 200, which in one embodiment is computer 102 depicted in FIG. 1, includes a general population component 202 and an individual patient component 204. Within general population component 202 and individual patient component 204 are one or more processors (such as processor 104 depicted in FIG. 1, but not depicted in FIG. 2) that perform one or more of the described steps 1-5.

In step 1, an abstraction of a candidate feature is generated. Candidate features being abstracted/generated vary over time. That is, the abstraction of the candidate feature creates a model of how one or more biological features for a patient vary over time, in order to form an abstracted set of candidate variance-related patient features. As described herein, these variances to the patient features are temporally heteroskedastic (i.e., vary differently during different periods of time and according to how the periods of time are subdivided for analysis). The variances may be univariate or multivariate.

For example, consider a univariate model in which a single type of biological event is measured. An exemplary univariate model is a measured low blood cell count (the single type of biological event). A low blood cell count often leads to an extensive proliferation of hematopoietic stem cells, which often leads to leukemia (the end point). That is, if a patient has a low blood cell count (i.e., a reduced number of red blood cells and/or white blood cells), the body with generate more hematopoietic stem cells. These hematopoietic stem cells are precursor cells from which red blood cells (erythrocytes) and white blood cells (e.g., lymphocytes) are formed. In the case of white blood cells, the hematopoietic stem cells form intermediary immature white blood cells, calls blasts. These blasts then transform into mature white blood cells. If a patient is exposed to radiation or other environmental mutagens while the hematopoietic stem cells are transforming into the immature white blood cells exposures (blasts), then these blasts are at risk of mutation and an abnormal increase in number (i.e., leukemia). Thus, repeated negative spikes (i.e., reduction) in the blood count of a patient are indicative of the patient being at a greater risk of leukemia.

A multivariate model, as the name implies, utilizes multiple biological events showing variances. For example, consider a patient who has undergone general anesthesia during surgery. Undergoing general anesthesia may impact multiple patient features, including the ability to problem solve, memory (short term and long term), mood, etc. By quantitatively measuring such features (e.g., through Functional Magnetic Resonance Imaging (FRMI), written/oral testing, etc.), fluctuations in such multiple abilities can be measured. As described herein, such fluctuations (variances) can be used to predict an ultimate end point (e.g., level of cognitive health) for a population of patients and/or a particular patient.

This variance in biological features, which will be used in one or more embodiments of the present invention to predict end points, may be according to how much they vary (amplitude based) or how often they vary (frequency based).

Thus, in one embodiment, the measured variances are amplitude-based. That is, an event may fluctuate across different ranges. For example, a blood count for red blood cells may fluctuate between 3.0 (million cells per microliter) and 6.0 during a first extended time period, and may fluctuate between 4.0 and 5.0 during a second extended time period. Thus, the amplitude-based variance is greater during the first extended time period (6.0−3.0=3.0) than the second extended time period (5.0−4.0=1.0). This variance is therefore called an “amplitude-based variance”.

In one embodiment, the measured variances are frequency-based. That is, an event (e.g., decrease in blood cells, measured cognitive ability, etc.) may fluctuate at different frequencies, such that the variance of the measured event is more common (i.e., more frequent) at certain times than at other times. For example, blood cells may decrease to level X in a cyclic manner every 7 days during a first extended time period, and every 3 days during a second extended time period. Thus, the frequency of variance is greater during the second extended time period (every 3 days) than the first extended time period (every 7 days). This variance is therefore called a “frequency-based variance”.

Referring again to FIG. 2, once a complete feature set is generated (i.e., according to how one or more patient attributes vary over time), the complete feature set is optimized (step 2). This optimization is performed by analyzing selected variance features from the complete feature set (i.e., the abstracted/constructed patient features). This optimization includes identifying when certain variances are maximized. In one or more embodiments of the present invention, this optimization utilizes a VARiance trend Over Time (VAROT) algorithm, which is discussed in detail below. VAROT analyzes variances according to length of observation windows as well as incremental periods therein. That is, assume that there are three time divisions (observation windows) during which patient features are monitored. Not only will the variances in these patient features vary between the three time divisions, but the variances will also depend on which interim time periods (incremental periods) are used in each of the time divisions.

As described in step 3 of FIG. 2, once the optimized feature subset is created (i.e., a model showing points in time at variances are maximized), input data sources from a general population are mined, in order to match that data to the optimized feature subset. Thus, real-life data is located that matches the optimized feature subset, including the predicted end point. That is, step 3 finds databases that include the optimized feature subset (including when variances are maximized), as well as data that describes the predicted end point (e.g., an onset of a disease in the populations described by the input databases) occurring for patients whose features match those from the optimized feature subset.

As described in step 4 of FIG. 2, the populated optimized feature subset (i.e., the “feature population”) is then compared to data from database 206 and/or database 208 for an individual patient. In one embodiment, database 206 and/or database 208 are provided by data storage system 152 depicted in FIG. 1. Database 206 includes data from the Electronic Health Records/Personal Health Records (EHR/PHR) for a particular patient. Data from database 206 includes historical data about that particular patient, including lab results, x-rays, clinical notes, etc. Database 208 includes real-time data about a patient, coming from portable heart monitors, glucose monitors, and other sensors that measure real-time conditions for a patient. The data from database 206 and/or database 208 is used to generate an optimized feature subset, similar in format to that created in step 2 for a wide population of patients. If there is a match between the optimized feature subset created for the current patient and the optimized feature subset created for the general population (from step 2), then an alert is set. In one embodiment, this alert indicates that there is such a match only if the optimized feature subset exceeds a particular baseline for that patient. For example, a particular patient may have a heart rate that routinely fluctuates into the abnormally low range. However, database 206 confirms that this patient has an “athlete's heart”, in which bradycardia is simply caused by a high level of conditioning in that patient, not by any pathology.

As described in step 5 of FIG. 2, a determination is made as to whether the optimized feature subset actually matches a Key Performance Indicator (KPI) desired for a particular patient. For example, assume that the user wants to know if a patient is at risk for a stroke. The data from databases 206 and 208 may be able to generate several different optimized feature subsets for the current patient. However, it is only the optimized feature subset that has “stroke” as the end point that is useful for predicting the risk of the current patient having a stroke.

Similarly, step 5 adjusts the optimized feature subset for the general population (step 3) with data for the current patient, since the current patient is also part of the general population.

Once a match is found between a particular optimized feature subset from the general population (that includes the desired KPI) and the optimized feature subset for the current patient, an individually adapted plan (alert, intervention, therapy, treatment) is created for the current patient (block 210).

Additional details of steps 1-5 shown in FIG. 2 are now presented.

### Step 1: Feature Abstraction

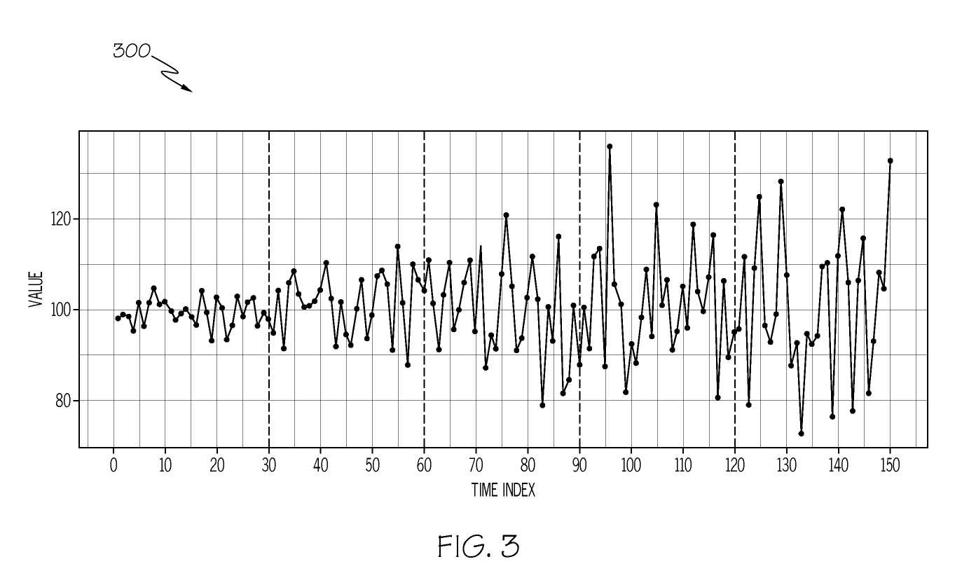

Feature abstraction defines a particular candidate patient feature for predicting a particular condition or event. Starting now with FIG. 3, a chart 300 depicts a simulated sequence of patient health measurements. These patient health measurements may be derived from a patient's medical history (e.g., from database 206 shown in FIG. 2) and/or from raw data from sensors (e.g., routed through database 208 shown in FIG. 2). The measurements may be values from a blood workup, vital signs (temperature, pulse respiration rates), insulin levels, etc. In one embodiment, the patient features are univariate (i.e., only look at a single type of patient measurement). In another embodiment, the patient features are multivariate (i.e., take into account multiple types of patient measurements).

Thus, assume that the chart 300 depicts a simulated sequence of measures x (i.e., a single patient feature x), with a length of 150 days from start to finish, generated by using normal distribution with a constant mean (mu=100) and non-constant variance over time. In this example, the observation window starts from the 30^{th} day (the first vertical dash line) and ends at 120^{th} day (the last vertical dash line). The observation window is divided into three periods (dt) with dt=30 days. Thus, the first period is from day 30 to day 60; the second period is from day 60 to day 90; and the third period is from day 90 to day 120. In this example, the period type is set to “discrete” (i.e., having a fixed period from a starting point “0”, rather than a “rolling” period that resets each new day to look at the next 30 days from the latest new day). Finally, assume that a constraint is defined to state that each period must have at least 10 measures (s=10) in order for the measurements to be valid.

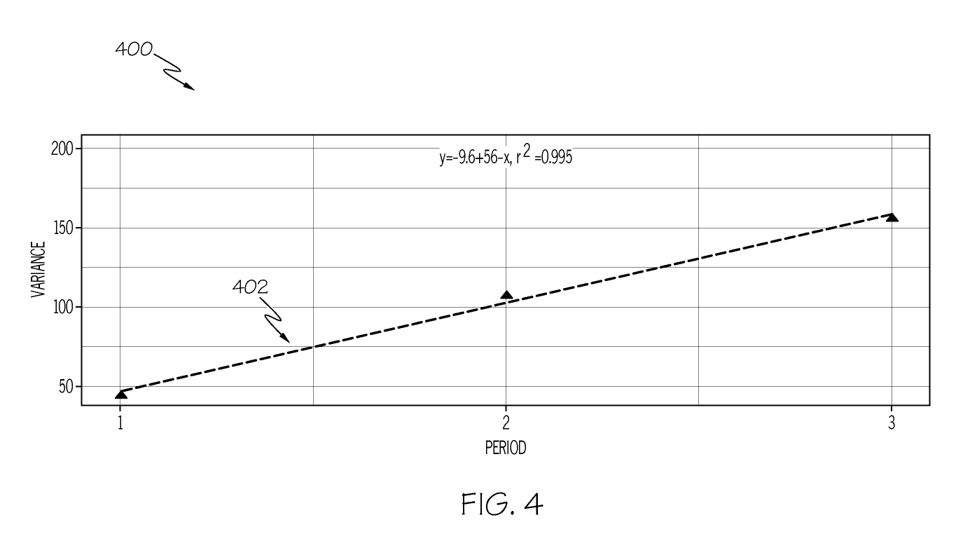

FIG. 4 depicts a chart 400 that illustrates an estimated trend variance for the patient health measurements shown in FIG. 3. Chart 400 illustrates the estimated variance and its trend over time. The three depicted triangles are sample variances in each of the three periods described above for chart 300. The slope of the line 402 through the triangles is positive, thus indicating that there is an upward amount of variances being measured/detected in chart 300. Line 402, fitted by Ordinary Least Squares (OLS), is the estimated VARiance trend Over Time (VAROT) for the data shown in chart 300.

Note that the VAROT depicted in chart 400 is only an estimate, since it does not take into account subdivisions in the three time divisions depicted by the triangles in chart 400. An optimized version of VAROT takes such subdivisions into account, as now described. VAROT is abstracted from a sequence of measures indexed by time for a predefined observation window. Generally speaking, VAROT is written as a function:

VAROT=f(x,tₛ,wl,dt,pt,s)

where:
x is a sequence of measures indexed by time;
tₛ is a starting point of an observation window;
wl is a length of the observation window(s);
dt is an incremental period within one or more of the observation window(s);
pt describes a constraint for the period type (either discrete or rolling period); and
s describes a constraint for sparsity (minimum requirement for data availability in each period).

However, the VAROT shown in FIG. 4 is merely a statistical approximation. In order to establish a VAROT that is more useful, the VAROT is optimized, thus creating an optimized feature subset (see step 2 in FIG. 2).

### Step 2: Feature Optimization

Obtaining a full sequence of measures does not reveal the sub-period which has the steepest variance trend in patient's history. VAROT abstracted from a sub-period with larger variance slope (in absolute values) is likely to be more related to patient's outcome in the future. Thus, an optimization framework searches for the optimal set of parameters that returns the strongest VAROT signals in the patient's time indexed measures.

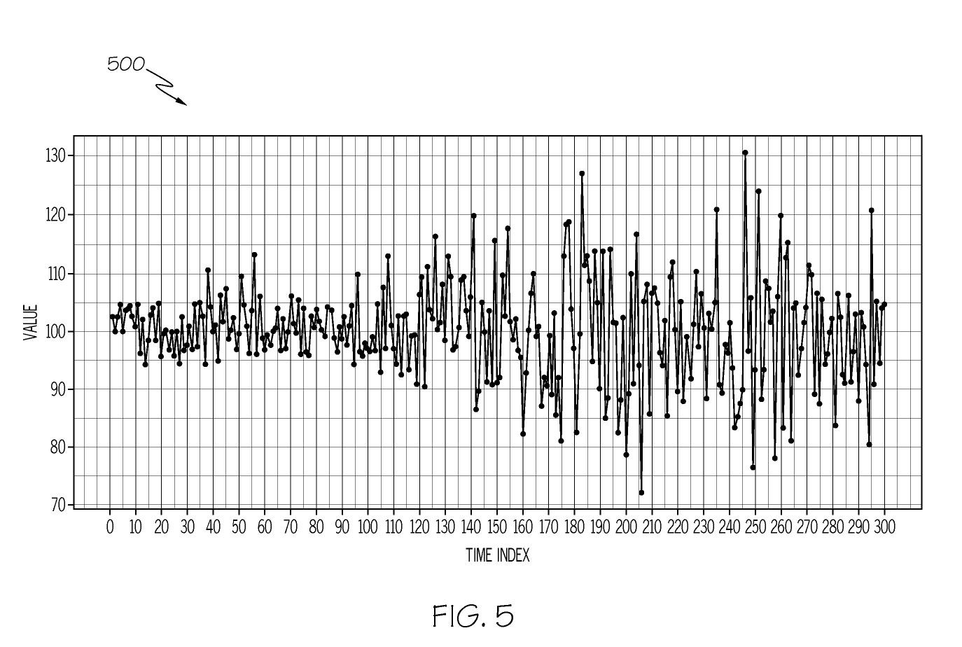

With reference now to FIG. 5, chart 500 depicts another simulated sequence of patient health measurements. A casual observation notes that there appears to be a greater amount of amplitude variance as time passes. However, within the entire time period of 300 days depicted in chart 500, there may be certain sections in which the amplitude varies more. That is, assume that one spike ranges between 70 and 130, and the spikes just before and after this 70/130 variance are between 80 and 120. Thus, the 70/130 range (varying 60 points) and its 80/120 neighbors (varying 40 points) have a variance range difference of 20 (60-40) points. Assume further that there is also a spike that ranges between 80 and 120 (varying only 40 points), but the spikes before and after this 80/120 spike were only 90/100. Thus, the 80/120 range (varying 40 points) and its 90/100 neighbors (varying 10 points) have a variance range difference of 30 (40-10) points. That is, although the absolute fluctuation range is higher for the 70/130 spike (60 points) than the 80/120 spike (40 points), the change in range from previous and following spikes is greater for the 80/120 spike (variance range difference between it and neighboring spikes of 30) than the 70/130 spike (variance range difference between it and neighboring spikes of 20). In order to identify where such maximum variance range differences occur, the VAROT formula described herein is utilized.

Assume that, for the data points shown in chart 500 in FIG. 5, the following VAROT formula was used:

VAROT=f(x,tₛ=90,wl=(30,60,90,120),dt=(5,10,15,20,25,30,35,30),pt=“discrete”,s=10)

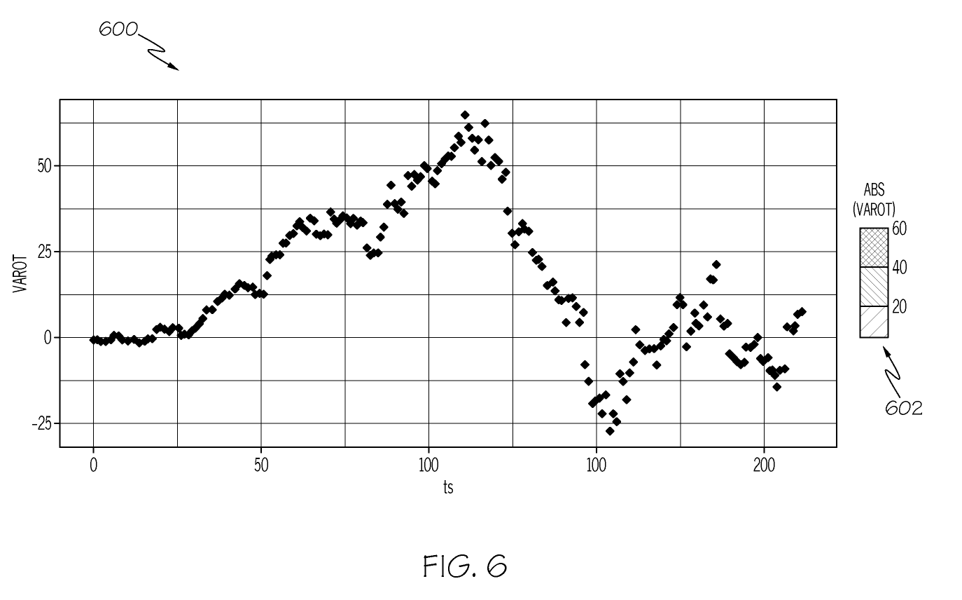

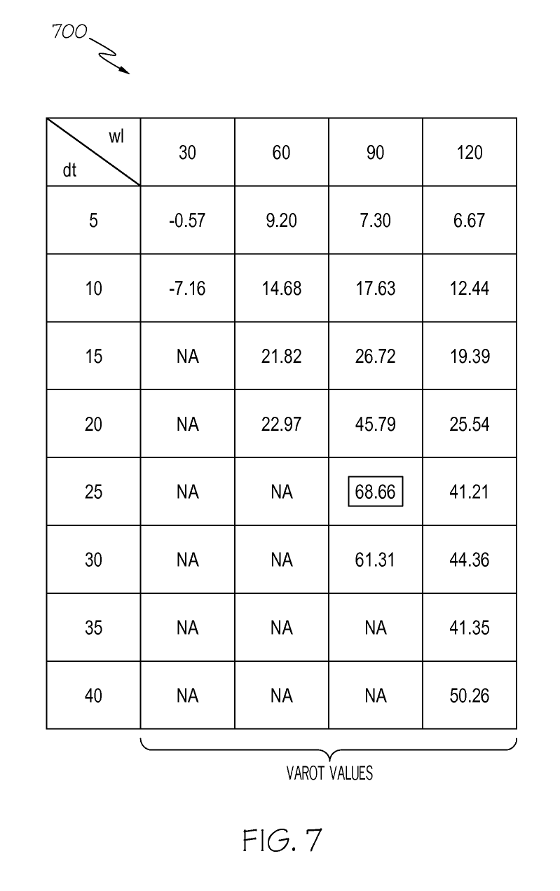

Using these values, chart 600 in FIG. 6 depicts the VAROT values for patient health measurements depicted in FIG. 5. Note that the plotted points in chart 600 can be color coded, according to a legend 602, showing the times at which VAROT is at a maximum (indicating maximum variances in recorded data), such as between time 100 and 125. Note further that VAROT result is at a minimum (indicating minimum variances in recorded data) around time 150. Thus, table 700 in FIG. 7 shows VAROT measurements according to permutations of various incremental periods of different observation windows used in the measurements shown in FIG. 5. As depicted in table 700, the maximum variance (as indicated by VAROT value 68.66) occurs between time 90 (tₛ) and time 180 (wl=90) when this time period is divided into blocks of 25 days (dt=25).

### Step 3: Feature Population

As described herein, once an optimized feature subset is established using the VAROT formula, the optimized feature subset is configured to receive identification input data sources for the general population. Thus, databases that comport with the abstracted/candidate trends created in steps 1-2 populate a database that is identified as such, thus making the data available at the individual level for specific patients. This data driven approach is taken where the data is to be derived for an individual to make reliable judgments on intervention.

Note that data can be obtained from Electronic Health Record (EHR), Personal Health Record (PHR) and Device data for both the general population as well as the specific patient. As also described above, univariate as well as multivariate data can be used for VAROT feature abstraction.

Certain key design factors considered in feature creation can be used as a starting point to analyze a variance over time matrix (e.g., table 700 shown in FIG. 7) that is generated by the VAROT algorithm. That is, when setting the parameters for the VAROT algorithm, consideration is given to:

The number of readings that are available;
Frequency of available readings;
Time of observation (i.e., total period of observation—from tₛ through tₛ+wl);
Incremental time (i.e. daily, weekly, monthly, quarterly−dt);
Data sensitivity (i.e., how much is the data affected by environmental conditions, seasonal changes, individual patient actions, etc.);
Time interval design (wl);
Permitted levels of fluctuation (i.e., disregarding anomalous spikes that exceed a predefined limit, and thus are likely artifacts);
Type of device used to obtain real-time readings;
Acceptable levels of sparsity in data (s);
Length of the observation window (wl);
Moving window or discrete window (pt);
Post meal/pre meal consideration (i.e., patient activities that affect readings, such as diet, drink, exercise, etc.); and
Response variables knowledge (i.e., other information that explains why a variance may occur).

### Step 4: Alert Setting

As described herein, baseline data can be used to understand the normal variance and to construct the upper and lower control limits. That is, an alert is generated when a current patient's optimized feature subset matches the general population's optimized feature subset for patients that reach a particular end point (e.g., develop a medical condition). Once trending of the variance is seen, quality control charts and alerts are set up accordingly. Based on the individual calibrations using the variance techniques/alerts, triggers are created for the health care provider to see the points of reflections in the case management.

In one embodiment, alerts are used to prompt the development of a personalized care plan based on the most predictive VAROT feature for the patient. This in turn can help design the intervention space and potentially use it as the basis for evidence generation for intervention optimization.

In one embodiment, alerts serve as a basis for developing adherence programs, which form a basis for patient self-management, using self-efficacy intervention or any coordinated care.

Step 5: Feature learning for adaptation

Once the current patient's optimized feature subset is matched to an optimized feature subset for the general population (of medical patients), the system verifies and reconfirms that the selected abstraction is the right one for the individual. That is, a confirmation is made that the optimized feature subset for the general population of patients results in an end point (Key Performance Indicator—KPI) that is desired (e.g., prediction of a particular medical condition).

Note further that different data readings are prompted by different events. For example, patient data may start to be read when a patient has surgery, starts taking a certain medication, begins physical therapy, etc. This results in a tₛ (described above) that will affect what data is considered, thus creating time gates, which triggers a check for determining if the selected feature is the optimal one.

Note that the current VAROT process allows the system to differentiate patients according to their medical needs. That is, by predicting how likely a certain class of patients are to reach a certain endpoint (e.g., develop a medical condition) according to the strength of their VAROT values, then medical resources can be allocated accordingly. Thus, in one embodiment, the process described herein uses statistical modeling techniques (e.g., mixed modeling) to segment patients based on the optimized set derived from the VAROT algorithm, data availability, and data completeness for prediction of the same outcome.

Note that, as described herein, even though analysis is performed at the population level, intervention techniques are applicable at the individual level.

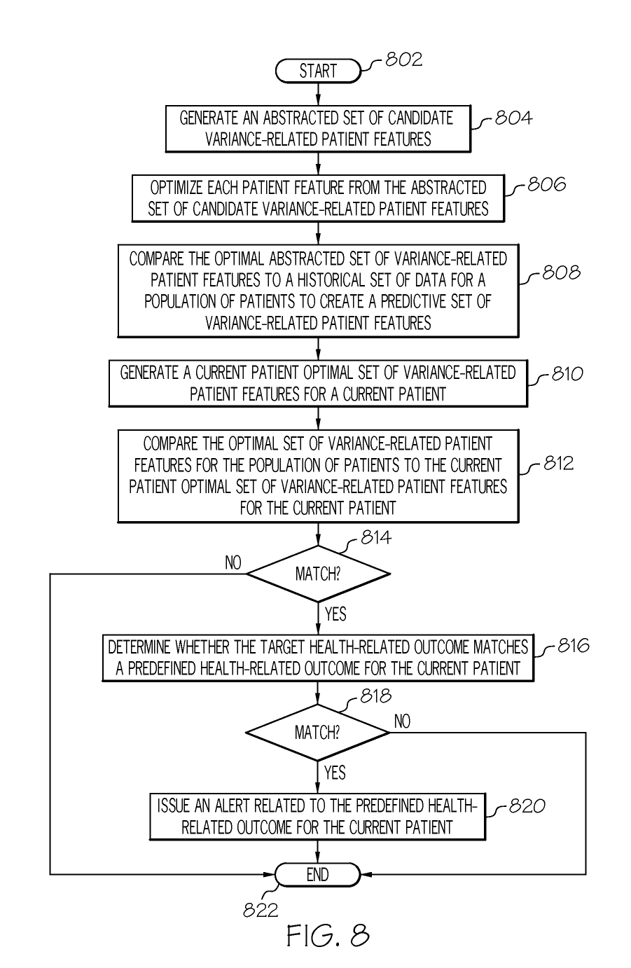

With reference now to FIG. 8, a high level flow-chart of one or more operations performed by one or more processors to abstract and select an optimal set of variance-related features that are indicative of an individual outcome and personalized plan selection in health care is presented.

After initiator block 802, an abstracted set of candidate variance-related patient features is generated by one or more processors (block 804). The abstracted set of candidate variance-related patient features are temporally heteroskedastic features. The term “temporally heteroskedastic features” is defined as features that change according to 1) the time from a particular event at which they occur (as per variables tₛ and wl in the VAROT algorithm described herein), and 2) according to the time intervals at which the features are measured (as per variable dt in the VAROT algorithm).

As described in block 806, one or more processors then optimize each patient feature from the abstracted set of candidate variance-related patient features by identifying a time period in which variances and heteroskedasticity of each patient feature are maximized, where the optimizing creates an optimal abstracted set of variance-related patient features from the time period in which the variances and heteroskedasticity of each patient feature are maximized. For example, in chart 600 in FIG. 6, the VAROT formula identifies the variance of a particular patient feature to be heteroskedastically maximized (i.e., reaches 68.66) at the time between time mark 90 and time mark 180 when this time span is partitioned into time segments of 25 units (see table 700).

As described in block 808 of FIG. 8, one or more processors then compare the optimal abstracted set of variance-related patient features to a historical set of data for a population of patients to create a predictive set of variance-related patient features. As described herein, this predictive set of variance-related patient features predict a target health-related outcome of the population of patients.

As described in block 810 of FIG. 8, one or more processors then generate a current patient optimal set of variance-related patient features for a current patient. As described in block 812, one or more processors then compare the optimal set of variance-related patient features for the population of patients to the current patient optimal set of variance-related patient features for the current patient. If there is a match (query block 814) (i.e., if the optimal set of variance-related patient features for the population of patients matches the current patient optimal set of variance-related patient features for the current patient within a predefined limit), then one or more processors determine whether the target health-related outcome matches a predefined health-related outcome for the current patient (block 816). That is, a determination is made to confirm that the candidate variance-related patient will actual lead to a KPI (e.g., prediction of a diagnosis of a particular disease) that is desired (query block 818).

As described in block 820, if there is a match between the target health-related outcome and the predefined health-related outcome for the current patient, then one or more processors issues an alert related to the predefined health-related outcome for the current patient. This alert may be a warning of an increased risk of a disease, a recommended course of action to prevent/treat the disease, etc. The process ends at terminator block 822.

In one embodiment of the present invention, the time period in which variances and heteroskedasticity of each patient feature are maximized is identified by: generating, by one or more processors, a plurality of time segment sizes; generating, by one or more processors, a plurality of time sub-segment sizes; creating, by one or more processors, various permutations of the plurality of time segment sizes with the plurality of time sub-segment sizes; and identifying, by one or more processors, an optimal combination of a particular time segment size with a particular time sub-segment size within which the variances and heteroskedasticity of each patient feature are maximized.

In one embodiment of the preset invention, one or more processors establishes, based on historical data for the current patient, a normal variance in the current patient optimal set of variance-related patient features for the current patient, where the normal variance has been predetermined to not be predictive of a medical condition in the current patient. For example, the current patient may have a slow heart rate that is “normal” (i.e., not harmful) for that current patient. One or more processors determines whether the current patient optimal set of variance-related patient features for the current patient exceeds the normal variance. In response to determining that the current patient optimal set of variance-related patient features for the current patient exceeds the normal variance, then one or more processors issues the alert related to the predetermined health-related outcome for the current patient.

In one embodiment of the present invention, the predetermined health-related outcome for the current patient is implementation of a medical treatment plan to cure a medical condition suffered by the current patient. In this embodiment, the method further comprises: determining, by one or more processors, whether the implementation of the medical treatment plan cured the medical condition in the current patient within a predetermined amount of time; and in response to determining that implementation of the medical treatment plan did not cure the medical condition in the current patient within the predetermined amount of time, selecting, by one or more processors, a new set of variance-related patient features for the current patient for generation of a new current patient optimal set of variance-related patient features for the current patient.

In one embodiment of the present invention, one or more processors identify a trend in the temporally heteroskedastic features, wherein a positive trend indicates a temporal increase in variances to the temporally heteroskedastic features, wherein a negative trend indicates a temporal decrease in variances to the temporally heteroskedastic features, and wherein the positive trend and the negative trend describe changes in an amplitude of the variances to the temporally heteroskedastic features over time. In response to detecting a positive trend in the temporally heteroskedastic features, one or more processors issue the alert related to the predefined health-related outcome for the current patient.

In one embodiment of the present invention, the abstracted set of candidate variance-related patient features for the general population, as well as variance-related patient features for the current patient, is generated by one or more processors by maximizing a Variance Trend Over Time (VAROT), wherein:

VAROT=f(x,tₛ,wl,dt,pt,s)
where
x=a measurements of predefined measured patient trait,
tₛ=a starting point of an observation window for observing the predefined measured patient trait,
wl=a length of the observation window,
dt=an incremental period of length for a subunit of the observation window,
pt=a period type for the observation window, wherein the period type is selected from a group consisting of a discrete period and a rolling period, and
s=a sparsity constraint that defines a required minimum number of data points for x within the incremental period in the observation window.

In one embodiment of the present invention, the starting point of the observation window described in the VAROT formula is triggered by a predetermined event related to the current patient. In one embodiment of the present invention, this predetermined event related to the current patient is an inception of a pharmacological protocol being applied to the current patient. In one embodiment of the present invention, this predetermined event related to the current patient is surgery being performed on the current patient. In one embodiment, this predetermined event related to the current patient is a dietary event occurring with the current patient.

As described herein, the present invention describes a method and system to help in the abstraction, construction and population of new features emphasizing the variability of metrics over time (heteroskedasticity), thus enabling (but not limited to) the use of insights from that feature in designing/monitoring/adapting care management services such as adherence. The system also includes a learning component that leverages individual historical data to evaluate the sensitivity of the chosen feature abstractions.

The data-driven approach described herein enables the capturing of temporal context associated with the metrics without the need for defining theoretical models and also provides the ability to continuously monitor the chosen abstractions and modify them.

### Use Cases

Clinical Diagnosis & Prognosis

One underlying concept of the present invention is that parameters of a biological model describing previous evolution of a system (or an organism) serve as predictors of end points. This prediction may be univariate or multivariate.

### Univariate Example

Low blood cell count results in extensive proliferation of hematopoietic stem cells. Since probabilities of mutations (ultimately resulting in leukemia) under radiation exposure are high, certain measurable characteristics of the blood count dynamics could be considered as risk factors for leukemia, e.g., speed and maximal decline of blood count in peripheral blood.

### Multivariate Example

Multivariate data collected on various human cognitive functions and their variances measured across time may be used to determine anesthesia's long-term effects on cognition. Some measures obtained in common analyses of the cognitive tests serve as predictors of future patient cognitive health and/or his/her quality of life.

The present invention utilizes two root reasonings in the analysis of variance (or other generalized variables) into feature abstractions and their applications: statistical and biological.

### Statistical Analysis

A statistical analysis builds statistically based predictors to determine their predictability in the end point. A logistic or linear fitted line (e.g., using the difference between the last and penultimate values of covariates, i.e., variance of previous measurements) is initially used as a trend line for trends of variance as predictor for the end point. These variances can be based on an increased variance in frequency or in an increased variance in data points (decreased interval between two consecutive data points). That is, there may be many variances occurring within a particular time period (“increased variance in frequency”), or there may simply be a “decreased interval between two consecutive data points” (i.e., two variances occur within a predetermined subset of time within a time period), regardless of how many variances occur over the entire time period.

Note that in one or more embodiments, mixed models are applied for segmenting patients based on significant abstraction of variance factors for prediction of the same outcome. That is, the VAROT formula described herein can identify certain populations/patients as likely having a certain predefined outcome.

### Biological Analysis

Although the present invention is described as relying on statistical tools, it is to be understood that the underlying data is based on biological/medical evidence, such that a correlation exists between variability in data attribute and the end point. That is, parameters of a biological model describe previous evolutions of a system (or an organism), which in one or more embodiments serve as predictors of end points. Examples of such biological analyses include, but are not limited to the following exemplary use cases:

Radiation exposure: Data collected on decreasing red blood cell count under exposure to radiation, as well as on stem cell regeneration acceleration to make up for loss of red blood cells, can be indicative of an increased risk for leukemia. The low blood cell count results in extensive proliferation of hematopoietic stem cells. Since probabilities of mutations (ultimately resulted in leukemia) under radiation exposure is high, certain measurable characteristics of the blood count dynamics are considered as risk factors for leukemia, e.g., speed and maximal decline of blood count in peripheral blood.

Kidney failure: Data collected on blood pressure levels during a surgery can be indicative of a greater risk of kidney failure. It is clinically known that an extended time with low blood pressure leads to kidney failure. Minutes in surgery with blood pressure below normal are thus used as predictor for kidney failure.

Heart disease: Blood pressure that is continuously/steadily high is less problematic than varying blood pressure. A calculated variance is more of a predictor of heart disease than the actual elevated values.

Cognitive functions (Multivariate data): Data collected on various human cognitive functions (sensing, thinking, etc.) and their variances measured across time are used to determine anesthesia's long-term effects on cognition. Some measures obtained in common analyses of the cognitive tests (e.g., using factor analysis or latent class analyses) serve as predictors of future patient cognitive health and/or his/her quality of life.

All of these use cases are able to utilize the VAROT formula described herein to accurately predict one or more particular outcomes/results.

### Personalized Treatment

Based on the predicted outcome/consequence/result/end point identified by the VAROT-based process described herein, (i.e., capturing variances across time for individual prognosis), personalized care plans and adherence programs can then be created. Creating a tailored treatment plan or specific intervention results in a favorable clinical actionable view point for the provider or the patient. For example, depending on the variances across time features where response variable is weight management, a personalized treatment plan leading to lifestyle and nutrition modifications can be adopted.

One or more embodiments of the present invention are thus useful in the field of Personalized Medication/Predictive Medicine. The goal of predictive medicine is to predict the probability of future disease so that health care professionals and the patient themselves can be proactive in instituting lifestyle modifications and increased physician surveillance. For example, bi-annual full body skin exams by a dermatologist or internist can be ordered if the patient is found to have an increased risk of melanoma. Similarly, an EKG and cardiology examination by a cardiologist can be ordered if a patient is found to be at increased risk for a cardiac arrhythmia. Similarly, alternating MRIs or mammograms can be ordered every six months if a patient is found to be at increased risk for breast cancer. Data analysis, using the VAROT-based process described herein, thus can be used in the area of Personalized Medication/Predictive Medicine.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A method to automatically abstract and select an optimal set of variance-related features that are indicative of an individual outcome in health care, the method comprising:
generating, by one or more processors, an abstracted set of candidate variance-related patient features, wherein the abstracted set of candidate variance-related patient features are temporally heteroskedastic features;
optimizing, by one or more processors, each patient feature from the abstracted set of candidate variance-related patient features by identifying a time period in which variances and heteroskedasticity of each patient feature are maximized, wherein said optimizing creates an optimal abstracted set of variance-related patient features from the time period in which the variances and heteroskedasticity of each patient feature are maximized;
comparing, by one or more processors, the optimal abstracted set of variance-related patient features to a historical set of data for a population of patients to create a predictive set of variance-related patient features, wherein the predictive set of variance-related patient features predicts a target health-related outcome of the population of patients;
generating, by one or more processors, a current patient optimal set of variance-related patient features for a current patient;
comparing, by one or more processors, the optimal set of variance-related patient features for the population of patients to the current patient optimal set of variance-related patient features for the current patient;
in response to the optimal set of variance-related patient features for the population of patients matching the current patient optimal set of variance-related patient features for the current patient within a predefined limit, determining, by one or more processors, whether the target health-related outcome matches a predefined health-related outcome for the current patient; and
in response to the target health-related outcome matching the predefined health-related outcome for the current patient, issuing, by one or more processors, an alert related to the predefined health-related outcome for the current patient.

2. The method of claim 1, wherein the time period in which variances and heteroskedasticity of each patient feature are maximized is identified by:
generating, by one or more processors, a plurality of time segment sizes;
generating, by one or more processors, a plurality of time sub-segment sizes;
creating, by one or more processors, multiple permutations of combinations of the plurality of time segment sizes with the plurality of time sub-segment sizes; and
identifying, by one or more processors, an optimal combination of a particular time segment size with a particular time sub-segment size within which the variances and heteroskedasticity of each patient feature are maximized.

3. The method of claim 1, further comprising:
establishing, by one or more processors and based on historical data for the current patient, a normal variance in the current patient optimal set of variance-related patient features for the current patient, wherein the normal variance has been predetermined to not be predictive of a medical condition in the current patient;
determining, by one or more processors, whether the current patient optimal set of variance-related patient features for the current patient exceeds the normal variance; and
in response to determining that the current patient optimal set of variance-related patient features for the current patient exceeds the normal variance, issuing, by one or more processors, the alert related to the predetermined health-related outcome for the current patient.

4. The method of claim 1, wherein the predetermined health-related outcome for the current patient is implementation of a medical treatment plan to cure a medical condition suffered by the current patient, and wherein the method further comprises:
determining, by one or more processors, whether the implementation of the medical treatment plan cured the medical condition in the current patient within a predetermined amount of time; and
in response to determining that implementation of the medical treatment plan did not cure the medical condition in the current patient within the predetermined amount of time, selecting, by one or more processors, a new set of variance-related patient features for the current patient for generation of a new current patient optimal set of variance-related patient features for the current patient.

5. The method of claim 1, further comprising:
identifying, by one or more processors, a trend in the temporally heteroskedastic features, wherein a positive trend indicates a temporal increase in variances to the temporally heteroskedastic features, wherein a negative trend indicates a temporal decrease in variances to the temporally heteroskedastic features, and wherein the positive trend and the negative trend describe changes in an amplitude of the variances to the temporally heteroskedastic features over time; and
in response to detecting a positive trend in the temporally heteroskedastic features, issuing, by one or more processors, the alert related to the predefined health-related outcome for the current patient.

6. The method of claim 1, wherein the abstracted set of candidate variance-related patient features is generated by one or more processors by maximizing a VARiance trend Over Time (VAROT), wherein:
VAROT=f(x,tₛ,wl,dt,pt,s)
where x=measurements of a predefined measured patient trait,
tₛ=a starting point of an observation window for observing the predefined measured patient trait,
wl=a length of the observation window,
dt=an incremental period of length for a subunit of the observation window,
pt=a period type for the observation window, wherein the period type is selected from a group consisting of a discrete period and a rolling period, and
s=a sparsity constraint that defines a required minimum number of data points for x within the incremental period in the observation window.

7. The method of claim 6, wherein the starting point of the observation window is triggered by a predetermined event related to the current patient.

8. The method of claim 7, wherein the predetermined event related to the current patient is an inception of a pharmacological protocol being applied to the current patient.

9. The method of claim 7, wherein the predetermined event related to the current patient is surgery being performed on the current patient.

10. The method of claim 7, wherein the predetermined event related to the current patient is a dietary event occurring with the current patient.

11. A computer program product for automatically abstracting and selecting an optimal set of variance-related features that are indicative of an individual outcome and personalized plan selection in health care, the computer program product comprising a computer readable storage medium having program code embodied therewith, the program code readable and executable by a processor to perform a method comprising:
generating an abstracted set of candidate variance-related patient features, wherein the abstracted set of candidate variance-related patient features are temporally heteroskedastic features;
optimizing each patient feature from the abstracted set of candidate variance-related patient features by identifying a time period in which variances and heteroskedasticity of each patient feature are maximized, wherein said optimizing creates an optimal abstracted set of variance-related patient features from the time period in which the variances and heteroskedasticity of each patient feature are maximized;
comparing the optimal abstracted set of variance-related patient features to a historical set of data for a population of patients to create a predictive set of variance-related patient features, wherein the predictive set of variance-related patient features predicts a target health-related outcome of the population of patients;
generating a current patient optimal set of variance-related patient features for a current patient;
comparing the optimal set of variance-related patient features for the population of patients to the current patient optimal set of variance-related patient features for the current patient;
in response to the optimal set of variance-related patient features for the population of patients matching the current patient optimal set of variance-related patient features for the current patient within a predefined limit, determining whether the target health-related outcome matches a predefined health-related outcome for the current patient; and
in response to the target health-related outcome matching the predefined health-related outcome for the current patient, issuing an alert related to the predefined health-related outcome for the current patient.

12. The computer program product of claim 11, wherein the time period in which variances and heteroskedasticity of each patient feature are maximized is identified by:
generating a plurality of time segment sizes;
generating a plurality of time sub-segment sizes;
creating multiple permutations of combinations of the plurality of time segment sizes with the plurality of time sub-segment sizes; and
identifying an optimal combination of a particular time segment size with a particular time sub-segment size within which the variances and heteroskedasticity of each patient feature are maximized.

13. The computer program product of claim 11, wherein the method further comprises:
establishing, based on historical data for the current patient, a normal variance in the current patient optimal set of variance-related patient features for the current patient, wherein the normal variance has been predetermined to not be predictive of a medical condition in the current patient;
determining whether the current patient optimal set of variance-related patient features for the current patient exceeds the normal variance; and
in response to determining that the current patient optimal set of variance-related patient features for the current patient exceeds the normal variance, issuing the alert related to the predetermined health-related outcome for the current patient.

14. The computer program product of claim 11, wherein the predetermined health-related outcome for the current patient is implementation of a medical treatment plan to cure a medical condition suffered by the current patient, and wherein the method further comprises:
determining whether the implementation of the medical treatment plan cured the medical condition in the current patient within a predetermined amount of time; and
in response to determining that implementation of the medical treatment plan did not cure the medical condition in the current patient within the predetermined amount of time, selecting a new set of variance-related patient features for the current patient for generation of a new current patient optimal set of variance-related patient features for the current patient.

15. The computer program product of claim 11, wherein the abstracted set of candidate variance-related patient features is generated by one or more processors by maximizing a VARiance trend Over Time (VAROT), wherein:
VAROT=f(x,tₛ,wl,dt,pt,s)
where x=measurements of a predefined measured patient trait,
tₛ=a starting point of an observation window for observing the predefined measured patient trait,
wl=a length of the observation window,
dt=an incremental period of length for a subunit of the observation window,
pt=a period type for the observation window, wherein the period type is selected from a group consisting of a discrete period and a rolling period, and
s=a sparsity constraint that defines a required minimum number of data points for x within the incremental period in the observation window.

16. A computer system comprising:
a processor, a computer readable memory, and a computer readable storage medium;
first program instructions to generate an abstracted set of candidate variance-related patient features, wherein the abstracted set of candidate variance-related patient features are temporally heteroskedastic features;
second program instructions to optimize each patient feature from the abstracted set of candidate variance-related patient features by identifying a time period in which variances and heteroskedasticity of each patient feature are maximized, wherein said optimizing creates an optimal abstracted set of variance-related patient features from the time period in which the variances and heteroskedasticity of each patient feature are maximized;
third program instructions to compare the optimal abstracted set of variance-related patient features to a historical set of data for a population of patients to create a predictive set of variance-related patient features, wherein the predictive set of variance-related patient features predicts a target health-related outcome of the population of patients;
fourth program instructions to generate a current patient optimal set of variance-related patient features for a current patient;
fifth program instructions to compare the optimal set of variance-related patient features for the population of patients to the current patient optimal set of variance-related patient features for the current patient;
sixth program instructions to, in response to the optimal set of variance-related patient features for the population of patients matching the current patient optimal set of variance-related patient features for the current patient within a predefined limit, determine whether the target health-related outcome matches a predefined health-related outcome for the current patient; and
seventh program instructions to, in response to the target health-related outcome matching the predefined health-related outcome for the current patient, issue an alert related to the predefined health-related outcome for the current patient; and wherein
the first, second, third, fourth, fifth, sixth, and seventh program instructions are stored on the computer readable storage medium and executed by the processor via the computer readable memory.

17. The computer system of claim 16, further comprising:
eighth program instructions to identify the time period in which variances and heteroskedasticity of each patient feature are maximized by:
generating a plurality of time segment sizes;
generating a plurality of time sub-segment sizes;
creating multiple permutations of combinations of the plurality of time segment sizes with the plurality of time sub-segment sizes; and
identifying an optimal combination of a particular time segment size with a particular time sub-segment size within which the variances and heteroskedasticity of each patient feature are maximized; and wherein
the eighth program instructions are stored on the computer readable storage medium and executed by the processor via the computer readable memory.

18. The computer system of claim 16, further comprising:
eighth program instructions to establish, based on historical data for the current patient, a normal variance in the current patient optimal set of variance-related patient features for the current patient, wherein the normal variance has been predetermined to not be predictive of a medical condition in the current patient;
ninth program instructions to determine whether the current patient optimal set of variance-related patient features for the current patient exceeds the normal variance; and
tenth program instructions to, in response to determining that the current patient optimal set of variance-related patient features for the current patient exceeds the normal variance, issue the alert related to the predetermined health-related outcome for the current patient; and wherein the eighth, ninth, and tenth program instructions are stored on the computer readable storage medium and executed by the processor via the computer readable memory.

19. The computer system of claim 16, wherein the predetermined health-related outcome for the current patient is implementation of a medical treatment plan to cure a medical condition suffered by the current patient, and wherein the computer system further comprises:
eighth program instructions to determine whether the implementation of the medical treatment plan cured the medical condition in the current patient within a predetermined amount of time; and
ninth program instructions to, in response to determining that implementation of the medical treatment plan did not cure the medical condition in the current patient within the predetermined amount of time, select a new set of variance-related patient features for the current patient for generation of a new current patient optimal set of variance-related patient features for the current patient; and wherein the eighth and ninth program instructions are stored on the computer readable storage medium and executed by the processor via the computer readable memory.

20. The computer system of claim 16, further comprising:
eighth program instructions for generating the abstracted set of candidate variance-related patient features by maximizing a VARiance trend Over Time (VAROT), wherein:
VAROT=f(x,tₛ,wl,dt,pt,s)
where x=measurements of a predefined measured patient trait,
tₛ=a starting point of an observation window for observing the predefined measured patient trait,
wl=a length of the observation window,
dt=an incremental period of length for a subunit of the observation window,
pt=a period type for the observation window, wherein the period type is selected from a group consisting of a discrete period and a rolling period, and
s=a sparsity constraint that defines a required minimum number of data points for x within the incremental period in the observation window; and wherein
the eighth program instructions are stored on the computer readable storage medium and executed by the processor via the computer readable memory.
